(19) United States
(12) Patent Application Publication
(10) Pub. No.: US 2022/0129198 A1
(43) Pub. Date: Apr. 28, 2022

(54) DATA UPDATES FOR CONTROLLERS

(71) Applicant: Hewlett-Packard Development Company, L.P., Spring, TX (US)

(72) Inventors: Wei Ze Liu, Spring, TX (US); Chengkai Yeh, Spring, TX (US); Jane Q. Shao, Spring, TX (US)

(73) Assignee: Hewlett-Packard Development Company, L.P., Spring, TX (US)

(21) Appl. No.: 17/297,196

(22) PCT Filed: Jul. 12, 2019
(86) PCT No.: PCT/US2019/041558

§ 371 Date: May 26, 2021

(51) Int. Cl. G06F 3/06

(52) U.S. Cl. CPC G06F 3/0659; G06F 3/0652; G06F 3/0679; G06F 3/0607; G06F 3/0619; G06F 3/064

(57) ABSTRACT

An example apparatus is provided. The example apparatus includes a component controller. The example apparatus includes a memory storage device associated with the component controller to store volatile data from the component controller and to store non-volatile data from the component controller in separate blocks of memory. The volatile data and the non-volatile data are to operate the component controller. The example apparatus also includes a memory controller in communication with the component controller and the memory storage device to write the volatile data from the component controller to the memory storage device. In addition, the example apparatus includes a central processor in communication with the memory storage device. The central processor is to execute a firmware variable service. The central processor is to receive the non-volatile data from the component controller. The non-volatile data is to be written to the memory storage device by the firmware variable service.

### BACKGROUND

Computing devices generally have many components. For example, most computing devices have a central processor. A computing device may also have other smaller processors or microcontrollers to control a specific component of the computing device, such as a graphics processing unit. Code and data for smaller processors and microcontrollers is typically stored in a non-volatile storage device, such as in a flash memory that is to be erased and re-written each time a change is to be made.

### BRIEF DESCRIPTION OF THE DRAWINGS

Reference will now be made, by way of example only, to the accompanying drawings in which:

FIG. 1 is a block diagram of an example apparatus to update data in a memory storage device;

FIG. 2 is a block diagram of another example apparatus to update data in a plurality of memory storage devices;

FIG. 3 is a block diagram of another example apparatus to update data in a memory storage device having multiple blocks of memory; and

FIG. 4 is a flowchart of an example of a method of updating data in a memory storage device.

### DETAILED DESCRIPTION

In modern computing devices, an increasing number of components are used to perform specific functions. Each of the components may include a separate processor, controller, or micro-controller to carry out various functions. By using a separate processor, controller, or micro-controller, some functions may be redirected from the central processor of the computing device to allow the central processor to focus on more resource intensive tasks.

For example, in some computing devices, a micro-controller may be used to collect timing data during a memory training process where the data is to be stored in a non-volatile memory. It is to be appreciated that while the micro-controller is carrying out the memory training in this example, the central processor is free to carry out other functions. This timing data may then subsequently be used by the central processor. Accordingly, by using the micro-controller, the central processor of the computing device avoid carrying out the memory training process, which may take significant time.

In other examples, the micro-controller may be used to collect data that is to be stored in a volatile memory such that it is erased or not stored after a session is over, such as when the computing device is rebooted. The micro-controller may be used to execute code to carry out the data collection process where the code may be stored in a non-volatile memory. The non-volatile memory is not particularly limited and may be any type of memory which maintains the data stored within after a power cycle or after the memory loses power. An example of non-volatile memory may be flash memory. From time to time, the code may be re-written, such as for a firmware update or other upgrade. Accordingly, the micro-controller may be used to write two different types of data.

While the central processor of the computing device may include modules and processes to prevent data loss during a write process to update data in a memory storage device, micro-controllers may be devices which are resource constrained. Accordingly, the processes that a micro-controller may be able to carry out to update the data in a memory storage device is limited. For example, a micro-controller may not be able to have sufficient resources to efficiently execute a fault tolerant write process to a memory storage device. Instead, the micro-controller may simply erase and write bytes in the memory storage device in a direct manner. However, without a fault tolerant process in place, the write process may be susceptible to failure or faults, especially if an interruption occurs during the write process, such as a power outage event.

In the examples described in greater detail below, an apparatus is provided to allow a micro-controller to update data in a memory storage device in a fault tolerant manner. In particular, the apparatus is able to separate the type of data or information to be written as either volatile or non-volatile. Since volatile memory is reset with each session, a likelihood of a fault such as a power outage affecting the write process upon restarting the computing device is reduced.

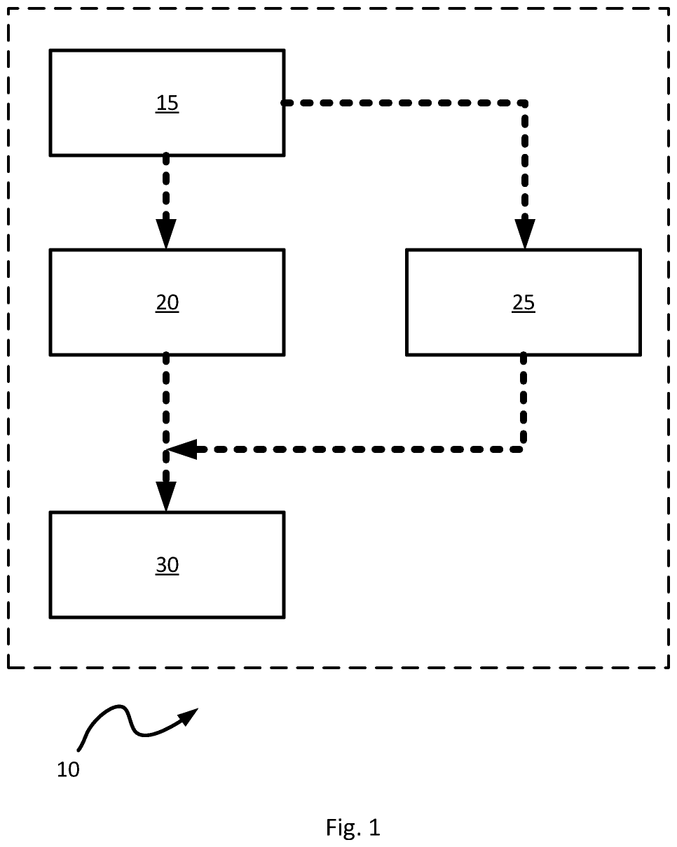

Referring to FIG. 1, an apparatus to update data in a memory storage device is shown at 10. The apparatus 10 may include other components, such as various interfaces and input/output devices such as display touchscreens to interact with a user. In addition, the apparatus 10 may include additional controllers or processors to carry out different functions within the computing device. The computing device may be a laptop, a tablet, a smartphone, a personal computer, a server, etc. In the present example, the apparatus 10 includes a component controller 15, a memory controller 20, a central processor 25, and a memory storage device 30.

The component controller 15 is to control a component of the computing device. In the present example, the component controller 15 may carry out a process in parallel with the central processor 25. The component controller 15 may also write non-volatile data and volatile data to update data stored in the memory storage device 30. In the present example, the non-volatile data is any type of data stored in the memory storage device 30 which is persists after a power cycle or after the memory storage device 30 loses power. Examples of non-volatile data may include the firmware for the component of the computing device associated with the component controller 15. The firmware may be instructions executable by the component controller 15 to provide low level control for the operation of the component at the hardware level. In the present example, the volatile data is any type of data stored in the memory storage device 30 which is lost after a power cycle or after the memory storage device 30 loses power. Examples of volatile data may include some settings, such as some user defined customization settings associated with the component. For example, settings may include user control over power settings of the component and/or other customization features. In general, upon the reset of the computing device, the volatile data is to reset to factory defaults unless the volatile data is maintained with an uninterrupted power source, such as a battery.

Accordingly, the component controller 15 is a separate chip having limited processing capabilities to operate a component of the computing system. For example, the component controller 15 may be a chip to carry out a memory training process in parallel with the central processor. As another example, the component controller 15 may be to control an output device of the computing system, such to render display data, or generate audio output from a speaker.

The memory controller 20 is in communication with the component controller 15 and the memory storage device 30. In the present example, the memory controller 20 may be similar to the component controller 15 with the exception that the memory controller 20 is dedicated to operating the memory storage device. The memory controller 20 is to write data from the component controller 15 to the memory storage device 30. In the present example, the memory controller 20 is a resource limited controller. In particular, the memory controller 20 may have capabilities to carry out simple write commands on the memory storage device 30. It is to be appreciated that the manner by which the memory controller 20 writes the data is not limited. For example, the memory controller 20 may write one byte at a time in the memory storage device 30. The memory controller 20 may also reset a byte to a default value, such as zero. In another example, the memory controller 20 may send a command to reset or erase a block of bytes in the memory storage device 30 prior to writing any data. Continuing with this example, once the bytes in the block of memory have been erased or reset to zero, the memory controller 20 may write data from the component controller 15 in the block of memory byte by byte in a sequential manner.

In the present example, the memory controller 20 is shown to be a separate component. However, it is to be appreciated that in some examples, the memory controller 20 may be part of the component controller 15. In other examples, the memory controller 20 may be a micro-controller in the memory storage device 30. In another example, the memory controller 20 may be a standalone micro-controller to receive instructions from a plurality of different controllers that may be associated with other components of the computing device.

In the present example, although the data to be written by the memory controller 20 is not limited, the memory controller 20 is to write volatile data from the component controller 15 to the memory storage device 30. The non-volatile data to be written to the memory storage device 30 from the component controller 15 is to be handled separately as described in greater detail below. The manner by which volatile data and non-volatile data is separated prior to being written to the memory storage device 30 is not limited. In the present example, the component controller 15 separates the volatile data from the non-volatile data. The volatile data is then forwarded to the memory controller 20 to write onto the memory storage device 30 whereas the non-volatile data is sent to the central processor 25. In other examples, the memory controller 20 may receive both the volatile data and the non-volatile data. In such an example, the memory controller 20 is to separate the volatile data from the non-volatile data and to forward the non-volatile data to the central processor 25.

In the present example, the central processor 25 is in communication with the memory storage device 30. In the present example, the central processor 25 is the main processing device of the computing system carrying out high level operations and operating several components of the computing system. In particular, the central processor 25 may communicate directly with various hardware components or with micro-controllers that operate the hardware components.

In addition, the central processor 25 is to receive commands to write data to the memory storage device 30. The manner by which the central processor 25 received data and instructions for writing to the memory storage device 30 is not limited. For example, the central processor 25 may receive a command along with data from the component controller 15 as shown in FIG. 1. In another example, the central processor 25 may receive data and instructions from the memory controller 20 as described above.

The central processor 25 is to execute a firmware variable service. The firmware variable service is to write data to the memory storage device 30. In the present example, the firmware variable service may be a unified extensible firmware interface to write data. Accordingly, the specification for the unified extensible firmware interface includes instructions that may be executed by the central processor 25 to write data to the memory storage device 30 in a fault tolerant manner. In other examples, the firmware variable service may be another service to be executed by the central processor 25 to write to the memory storage device 30 in a fault tolerant manner. Although the data to be written by the central processor 25 is not limited, the central processor 25 is to write non-volatile data from the component controller 15 to the memory storage device 30. As described above, the volatile data is separated and to be written to the memory storage device 30 via the memory controller 20.

In the present example, the memory storage device 30 is to be associated with the component controller 15. For example, the memory storage device 30 may be to store data associated with the component controller 15. The memory storage device 30 may be exclusively dedicated to the component controller 15 or the memory storage device 30 may be shared by multiple controllers. Furthermore, in the present example, the memory storage device 30 is to be capable of storing non-volatile data as well as volatile data. Accordingly, the memory storage device 30 is any component capable of storing data is hardware that may include multiple types of memory storage mediums. In the present example, the memory storage device 30 may include a non-volatile memory device, such as Electrically Erasable Programmable Read Only Memory (EEPROM) or flash memory. In addition, the memory storage device 30 may include storage for volatile data. Accordingly, the memory storage device 30 may include a volatile memory device, such as random access memory (RAM).

In the present example, the memory storage device 30 is to maintain separate portions depending on whether the data to be stored therein is volatile or non-volatile. Accordingly, the volatile data from the component controller 15 may be stored in a block of memory that is compatible with storing volatile data. In addition, the non-volatile data from the component controller 15 may be stored in another block of memory that is compatible with storing non-volatile data.

It is to be appreciated that in the present example, the volatile data is separated from the non-volatile data to improve the efficiency of programming the memory storage device 30 with a mixture of volatile data and non-volatile data. In particular, volatile data by definition is to be non-persistent such that it is erased or forgotten upon the completion of a session. Accordingly, if the computing device experiences a power outage during the data transfer to the memory storage device 30, the volatile data is not affected since the volatile data would have been erased with a restart of the computing device in any event. However, if the non-volatile data were to be interrupted during the data transfer to the memory storage device 30, the partially written data to the memory storage device 30 persists after the restart of the computing device. Upon restarting the computing device after the power outage event, the write process of the non-volatile data would not typically resume and the block of memory subject to the write process would be partially incomplete. This may lead to data corruption which may cause unintended consequences in the computing device. Furthermore, as the memory controller 20 does not have any procedure for dealing with such an event, a recovery procedure is not possible as the prior version of the block of memory is not recoverable. This may result in severe damage to the firmware operating on the computing device and may result in permanent damage that can “brick” the computing device such that there is no way to use the computing device again.

By using the firmware variable service of the central processor 25 to write the non-volatile data to the memory storage device 30, the potential damage from a power outage during the write process may be mitigated. Being a more resource intensive component of the computing system, the central processor 25 includes capabilities to carry out additional steps in the write process of the non-volatile data to protect the integrity of the data such as using fault tolerance modules to write the non-volatile data to the memory storage device 30. The fault tolerance modules of the central processor 25 are not limited and may be implemented in various manners. The general principle of the fault tolerance modules is to allow the computing device to survive a fault event such as a power outage as non-volatile data is being written. For example, in modern computing devices, it is typical for a user to make changes to the basic input/out device (BIOS) via a firmware variable service, such as a unified extensible firmware interface (UEFI). The UEFI allows the user to make changes and upon completing the changes, the UEFI writes the new BIOS settings to a memory storage device. The write process is inherently protected and if a power outage event occurs before the write process for the new settings is completed, the old settings are restored upon restarting the computing device. Accordingly, by using the same infrastructure to write non-volatile data from the component controller 15 to the memory storage device 30 instead of using the memory controller 20, a more robust write process may be used without having to increase the resources of the memory controller 20. In addition, by not using the central processor 25 to write the volatile data, resources of the central processor 25 are not used for a fault tolerant write process.

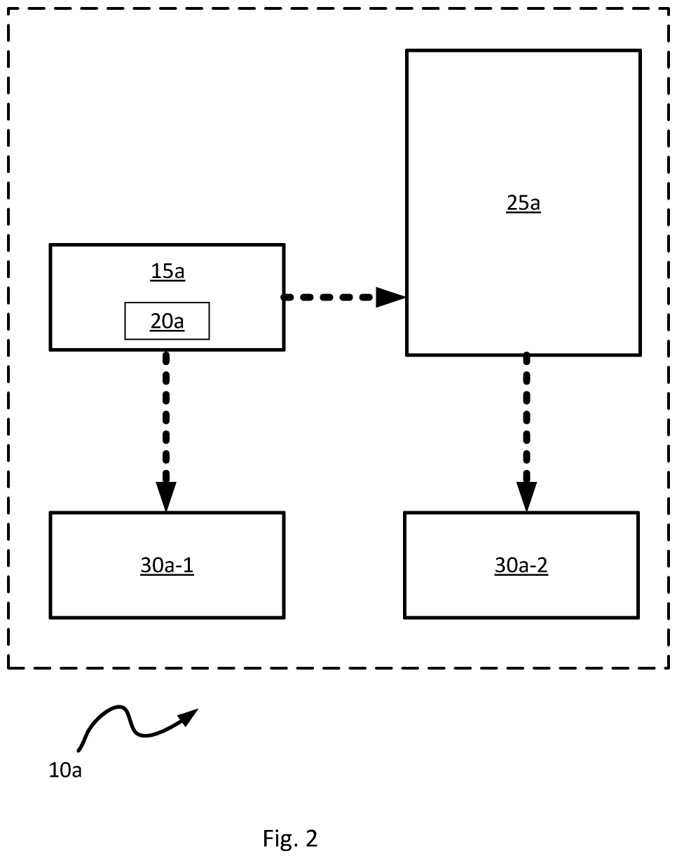

Referring to FIG. 2, another example of an apparatus to update data in a memory storage device generally shown at 10a. Like components of the apparatus 10a bear like reference to their counterparts in the apparatus 10, except followed by the suffix “a”. The apparatus 10a may include additional controllers or processors to carry out different functions within the computing device. In the present example, the apparatus 10a includes a micro-controller 15a, a memory controller engine 20a, a central processor 25a, and memory storage devices 30a-1 and 30a-2 (generically, these memory storage devices are referred to herein as “memory storage device 30a” and collectively they are referred to as “memory storage devices 30a”, this nomenclature is used elsewhere in this description).

In the present example, the micro-controller 15a may control a component or process of the computing device in parallel with the central processor 25a. The micro-controller may update data stored in the memory storage devices 30a also by writing persistent data and temporary data. To write data to the memory storage devices 30a, the micro-controller 15a includes a memory controller engine 20a.

The memory controller engine 20a is to write data from the micro-controller 15a to the memory storage device 30a. In the present example, the memory controller engine 20a is resource limited and includes limited capabilities to carry out simple write commands on the memory storage device 30a. It is to be appreciated that the manner by which the memory controller engine 20a writes the data is not limited. For example, the memory controller engine 20a may write one byte at a time in the memory storage device 30a. The memory controller engine 20a may also reset a byte to a default value, such as zero prior to writing data onto a memory storage device 30a. In another example, the memory controller engine 20a may send a command to reset or erase a block of bytes in a memory storage device 30a prior to writing any data. Continuing with this example, once the bytes in the block of memory have been erased or reset to zero, the memory controller engine 20a may write data from the micro-controller 15a in the block of memory byte by byte in a sequential manner.

In the present example, the memory storage devices 30a are to store data from the micro-controller 15a. The memory storage devices 30a may be exclusively dedicated to the micro-controller 15a or the memory storage devices 30a may be shared by multiple controllers or micro-controllers. In the present example, the memory storage device 30a-1 is to store temporary data. In the present example, temporary data may be data that is non-volatile or otherwise deleted after a period of time. For example, the data may be deleted after a predefined period of time or deleted based on an event or condition. Accordingly, the memory storage device 30a-1 may include a volatile memory device, such as random access memory (RAM). The memory storage device 30a-2 is to be store persistent data. In the present example, persistent data may be non-volatile data or any other data that will persist until an action, such as a command, is taken to expressly delete or modify the data. Accordingly, the memory storage device 30a-2 may include a non-volatile memory device, such as Electrically Erasable Programmable Read Only Memory (EEPROM) or flash memory.

Although the data to be written by the memory controller engine 20a is not limited, the memory controller engine 20a is to write temporary data from the micro-controller 15a to the memory storage device 30a-1 while the micro-controller 15a sends persistent data to the central processor 25a for writing to the memory storage device 30a-2. The manner by which temporary data and persistentdata are separated prior to being written to the memory storage device 30 is not limited. In the present example, the micro-controller 15a separates the temporary data from the persistentdata. The temporary data is then directly written to the memory storage device 30a-1 by the memory controller engine 20a. The persistentdata is then sent to the central processor 25a for writing onto the memory storage device 30a-2.

The central processor 25a is to execute a firmware variable service. The firmware variable service is to write data to the memory storage device 30a-2. In the present example, the firmware variable service may be a unified extensible firmware interface to write data. Accordingly, the specification for the unified extensible firmware interface includes instructions that may be executed by the central processor 25a to write data to the memory storage device 30a-2 in a fault tolerant manner. In other examples, the firmware variable service may be another service to be executed by the central processor 25a to write to the memory storage device 30a in a fault tolerant manner. Although the data to be written by the central processor 25a is not limited, the central processor 25a is to write persistent data from the micro-controller 15a to the memory storage device 30a-2.

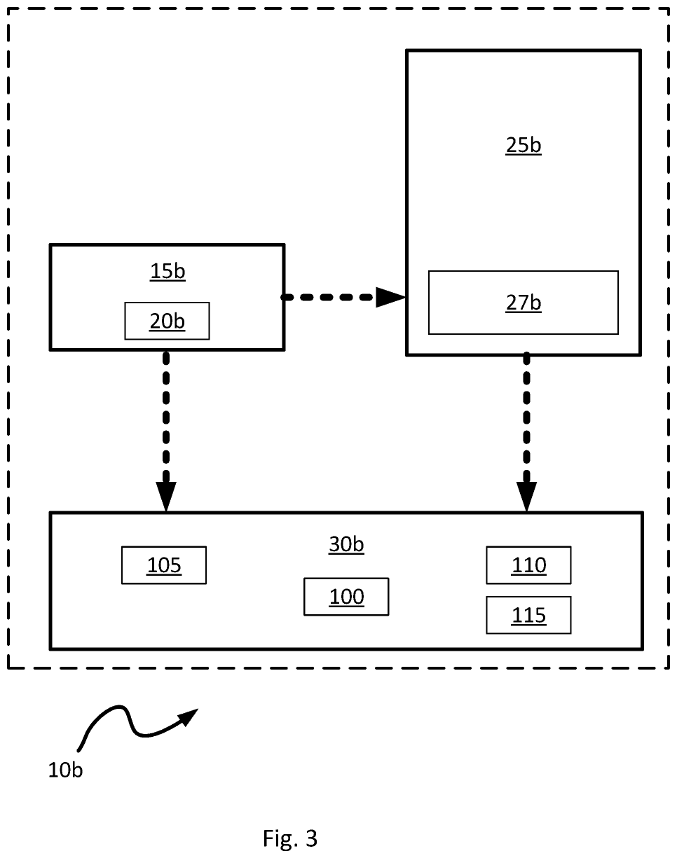

Referring to FIG. 3, another example of an apparatus to update data in a memory storage device generally shown at 10b. Like components of the apparatus 10b bear like reference to their counterparts in the apparatus 10a, except followed by the suffix “b”. The apparatus 10b may include additional controllers or processors to carry out different functions within the computing device. In the present example, the apparatus 10b includes a micro-controller 15b, a memory controller engine 20b, a central processor 25b, and a memory storage device 30b.

In the present example, the central processor 25b includes a fault tolerance engine 27b to execute a firmware variable service. The fault tolerance engine 27b is to carry out a write process of data on a block of memory in the memory storage device 30b. In particular, the fault tolerance engine 27b is to reduce corruption of a write process to the memory storage device 30b. For example, if a fault event such as a power outage occurs, the fault tolerance engine 27b is to restore the old data in the block of memory such that the component may continue to operate. The fault event is not particularly limited and may include any event that interrupts the write process. For example, a fault even may be a power outage or a communication issue.

In the present example, the memory storage device 30b may include a non-transitory machine-readable storage medium that may be any electronic, magnetic, optical, or other physical storage device. Furthermore, the memory storage device 30b maintain multiple blocks of memory for storing data associated with various services running on the computing device. In the present example, the memory storage device 30b may store data for several different components, which may include the code for various firmware of the computing device as well as temporary data. The memory storage device 30b includes an operating system 100, a block of memory 105 for temporary data and blocks of memory 110 and 115 for persistent data.

The operating system 100 includes code to be executable by the central processor 25b to provide general functionality to the computing device. For example, the operating system may provide functionality to additional applications. Examples of operating systems include Windows™, macOS™, iOS™, Android™, Linux™, and Unix™. The memory storage device 30b may additionally store instructions to operate at the driver level as well as other hardware drivers which may be part of the operating system 100 or separate from the operating system to communicate with other components and peripheral devices of the computing device.

The block of memory 105 is to receive data directly from the micro-controller 15b via commands from the memory controller engine 20b. Since the block of memory 105 memory is typically reset with each session, data in the block of memory 105 may not be significantly affected by a power outage during the write process and may not affect the write process upon restarting the computing device. Examples of temporary data to be stored in the block of memory 105 may include settings, such as user defined customization settings. For example, settings may include user control over power settings of the component and/or other customization features. In general, upon the reset of the computing device, the block of memory 105 may be erased and the temporary data is to be reset to factory defaults based on the code stored in the persistent data. In some examples, the block of memory 105 may be maintained with an uninterrupted power source, such as a battery.

The block of memory 110 and the block of memory 115 are non-volatile memory blocks storing persistent data. In the present example, the block of memory 110 and the block of memory 115 are to be used by the fault tolerance engine 27b to provide a fault tolerant write process. The block of memory 110 may be used to store the persistent data. If the central processor 25b receives a command to update or rewrite the data in the block of memory 110, the fault tolerance engine 27b may create a copy of the existing data from the block of memory 110 in the block of memory 115 prior to beginning the write process. Accordingly, a backup copy of the original content of the block of memory 110 may be maintained until the write process is completed. It is to be appreciated that in the event of a fault, such as a power outage while the fault tolerance engine 27b is writing the new data to the persistent block of memory 110, the copy in the block of memory 115 may be recovered and re-written to the block of memory 110. The recovery process may be part of the existing firmware which is executed upon the detection of corrupt data in the block of memory 110.

It is to be appreciated that the fault tolerance engine 27b may use other types of fault tolerant procedures. For example, instead of using the block of memory 115 as a backup, the fault tolerance engine 27b may begin writing the new persistent data to the block of memory 115 while the pointer to the data remains pointed to the block of memory 110. Upon a successful write process, the pointer may be switched to point to the block of memory 115 going forward. Accordingly, if the write process to the block of memory 115 were to be interrupted or the data is otherwise corrupted, the pointer would remain pointing at the block of memory 110 and no information would be lost since the corrupt or incomplete data is not be referenced by the micro-controller 15b.

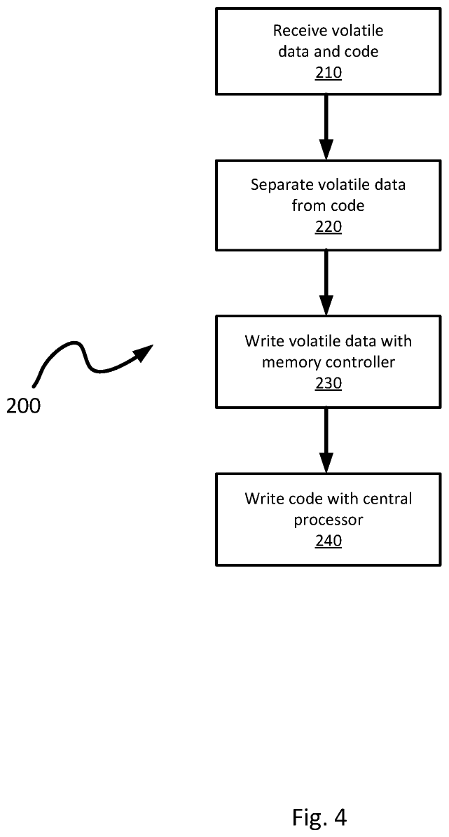

Referring to FIG. 4, a flowchart of a method of updating data in a memory storage device is shown at 200. Method 200 may be performed with the apparatus 10, the apparatus 10a, or the apparatus 10b. Indeed, the method 200 may be one way in which apparatus 50 or the apparatus 10 may be configured. Furthermore, the following discussion of method 200 may lead to a further understanding of the apparatus 10, the apparatus 10a, or the apparatus 10b and their various components. Furthermore, it is to be emphasized, that method 200 need not be performed in the exact sequence as shown, and various blocks may be performed in parallel rather than in sequence, or in a different sequence altogether. In the present example, each block of the method may be executed on a processor carrying out instructions stored on a non-transitory machine readable storage medium. It is to be appreciated that the storage medium may be the memory storage device 30 or another memory storage device located locally in the computing device or on another server over a network connection.

Block 210 involves receiving volatile data and code to be written to the memory storage device 30. The volatile data and code may be received at the component controller 15 and is not particularly limited. For example, the volatile data may include some data from a user to customize the operation of a component associated with the component controller 15. The code received may be a firmware upgrade for the component controller 15.

In block 220, the volatile data is separated from the code. The manner by which volatile data and non-volatile data is separated prior to being written to the memory storage device 30 is not limited. For example, the data may include an identifier indicating whether is it to be store as volatile data or non-volatile data. In other examples, the type of data may be determined based on a lookup table.

In block 230, the volatile data from the component controller is written to a block of memory in the memory storage device 30 using the memory controller 20. The manner by which this volatile data is written to the memory storage device 30 is not limited. In the present example, the volatile data is identified by the component controller 15 and provided to the memory controller 20. The memory controller 20 may delete or reset all the bytes in the block of memory to which the volatile data is written. This reset of the block of memory may occur prior to the beginning of the write process. Next, the memory controller 20 my write the volatile data to the block of memory in a byte by byte manner such that each byte in the block of memory is written in sequence. It is to be appreciated that this write process is simple and may be carried out by a memory controller 20 with constrained resources. However, if a fault event were to occur during the write process, such as after the block of memory has been erased, or if the volatile data were to be only partially written, the data would simply be reset to a default value since the data is not persistent.

Block 240 involves writing the code, such as a firmware upgrade, from the component controller 15 to another block of the memory storage device 30. It is to be appreciated that this block of memory is to be a non-volatile memory. In the present example, the central processor 25 is to be used to write the code using a fault tolerant write process. The manner by which the central processor 25 writes the code to the non-volatile block of memory is not limited. For example, the fault tolerant write process may involve using a module to reduce the likelihood of data corruption during the write process to the memory storage device 30. For example, the module may generate a copy of the existing code prior to a write process in the non-volatile block of memory prior to writing the new code to the non-volatile block of memory. The copy of the existing code may then be used as a backup in case the write process is not completed successfully, or in the event that the write process generated corrupt data. Accordingly, the copy of the existing code may be maintained until the write process is completed. In the event of a fault during the write process of the non-volatile data, a recovery process may be initiated to recover the existing data from the copy. In addition, it is to be appreciated that the copy of the existing code may also be used to roll back the change to the non-volatile block of memory if the new code is unstable or otherwise undesirable.

It should be recognized that features and aspects of the various examples provided above may be combined into further examples that also fall within the scope of the present disclosure.

What is claimed is:

1. An apparatus comprising:
a component controller;
a memory storage device associated with the component controller, wherein the memory storage device is to:
store volatile data from the component controller in a first block; and
store non-volatile data from the component controller in a second block, wherein the volatile data and the non-volatile data are to operate the component controller;
a memory controller in communication with the component controller and the memory storage device, wherein the memory controller is to write the volatile data from the component controller to the memory storage device; and
a central processor in communication with the memory storage device, wherein the central processor is to:
execute a firmware variable service; and
receive the non-volatile data from the component controller, the non-volatile data to be written to the memory storage device by the firmware variable service.

2. The apparatus of claim 1, wherein the memory controller is to erase the first block prior to writing the volatile data.

3. The apparatus of claim 2, wherein the memory controller is to write the volatile data to bytes in the first block sequentially.

4. The apparatus of claim 1, wherein the firmware variable service includes a fault tolerance engine to reduce corruption of a write process to the memory storage device.

5. The apparatus of claim 4, wherein the fault tolerance engine is to create a copy of existing data in the second block prior to the write process.

6. The apparatus of claim 5, wherein the copy of the existing data is maintained until the write process is complete, and wherein the fault tolerance engine is to recover the existing data from the copy of the existing data in after a fault.

7. A non-transitory machine-readable storage medium encoded with instructions when executed cause a processor of a computing device to:
receive, at a component controller, volatile data and code to be written to a memory storage device of the computing device;
separate, at the component controller, the volatile data from the code;
write the volatile data from the component controller to a first block of the memory storage device with a memory controller of the computing device; and
write the code from the component controller to a second block of the memory storage device with a central processor.

8. The non-transitory machine-readable storage medium of claim 7, wherein the instructions are executable to erase existing data in the first block prior to writing the volatile data.

9. The non-transitory machine-readable storage medium of claim 8, wherein the instructions are executable to write the volatile data to bytes in the first block sequentially.

10. The non-transitory machine-readable storage medium of claim 7, wherein the instructions are executable to reduce corruption of a write process to the memory storage device.

11. The non-transitory machine-readable storage medium of claim 10, wherein the instructions are executable to generate a copy of existing data in the second block prior to the write process.

12. The non-transitory machine-readable storage medium of claim 11, wherein the instructions are executable to maintain the copy of the existing data until the write process is complete.

13. The non-transitory machine-readable storage medium of claim 12, wherein the instructions are executable to recover the existing data from the copy of the existing data after a fault.

14. An apparatus comprising:
a controller having a memory controller engine;
a first memory storage device in communication with the controller, wherein the memory controller engine is to write temporary data from the controller to the first memory storage device;
a second memory storage device to store persistent data from the controller; and
a central processor in communication with the second memory storage device, wherein the central processor is to write the persistent data from the controller to the second memory storage device.

15. The apparatus of claim 14, wherein the central processor is to execute a fault tolerance engine to reduce corruption of a write process to the second memory storage device.
